(19) United States
(12) Patent Application Publication
(10) Pub. No.: US 2013/0162146 A1
(43) Pub. Date: Jun. 27, 2013

(54) ENERGY-SAVING LED LIGHTING DEVICE

(71) Applicant: CHIN-HONG CHANG, Taipei City (TW)

(72) Inventor: CHIN-HONG CHANG, Taipei City (TW)

(21) Appl. No.: 13/338,212

(22) Filed: Dec. 27, 2011

(51) Int. Cl. H05B 37/02

(52) U.S. Cl. 315/152

(57) ABSTRACT

An energy-saving LED lighting device includes a power source driving device, a lighting assembly, a human body detection device, and a sound control device. The human body detection device and the sound control device are arranged in the power source driving device. The energy-saving LED lighting device provided by the present invention arranges the human body detection device and the sound control device in the power source driving device so that in installation and use, there is no need to use additional remotely-located switch to control activation and deactivation and control of activation and deactivation of the lighting device can be simply realized through the installation of the energy-saving lighting device. The conditions for installation are lowered and the expense is saved.

### (a) TECHNICAL FIELD OF THE INVENTION

The present invention generally relates to the field of lighting devices, and more particularly to an LED (Light-Emitting Diode) lighting device.

### (b) DESCRIPTION OF THE PRIOR ART

Due to various advantages, energy-saving LED lighting devices are now commonly used in various fields. In installing a conventional LED lighting device, it needs to arranged a hand-operating switch at a nearby location to allow a person who needs lighting to manually open or close the switch in order to turning on/off the energy-saving lighting device. Or alternatively, a sound control switch or an infrared control switch is provided so that a user may control activation/deactivation of the energy-saving lighting device through voice or his or her body. In both situations, a remotely located switch must be provided (where the distance between the lighting device and the switch is connected by an electrical wire that is of a substantial length) to control the activation and deactivation of the energy-saving LED lighting device. This increases the installation expense and also imposes a high requirement for installation operation. Further, under a condition that no lighting or only dimmed lighting is desired, the conventional energy-saving LED lighting device shows a drawback of being incapable of automatic adjustment for saving energy.

### SUMMARY OF THE INVENTION

To overcome the above discussed drawback, the present invention provides an intelligent energy-saving LED lighting device that is only activated when needed. Such an energy-saving lighting device can control activation and deactivation of the energy-saving lighting device without installation of a remotely-located switch and can realize automatic adjustment for energy saving when no lighting or only a fraction of lighting of a lighting tube is desired.

The present invention is realized through the following technical solution:

An energy-saving LED lighting device comprises a power source driving device, a lighting assembly connected to the power source driving device, a human body detection device, and a sound control device. The human body detection device and the sound control device are arranged in the power source driving device.

The lighting assembly comprises at least two groups of lighting elements that are connected in parallel.

The lighting elements comprise at least one lighting unit.

The lighting elements comprise at least two lighting units connected in series.

The lighting units comprise light-emitting diodes.

The human body detection device comprises an infrared sensor and the sound control device comprises a voice sensor.

The advantages and beneficial effects are as follows:

The energy-saving LED lighting device provided by the present invention arranges the human body detection device and the sound control device in the power source driving device so that in installation and use, there is no need to use additional remotely-located switch to control activation and deactivation and control of activation and deactivation of the lighting device can be simply realized through the installation of the energy-saving lighting device. The conditions for installation are lowered and the expense is saved. Further, through arrangement of various groups of lighting elements to selectively light for various situations, incapability of automatic adjustment and energy saving in situations where no lighting or only dimmed lighting is desired can be overcome.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic circuit diagram of an energy-saving LED lighting device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides an energy-saving LED lighting device, which comprises a power source driving device 3, a lighting assembly connected to the power source driving device 3, a human body detection device 1, and a sound control device 2. The human body detection device 1 and the sound control device 2 are arranged in the power source driving device 3. The lighting assembly comprises a plurality of lighting elements 5, which can be controlled to individually light.

To more fully understand the technical features of the present invention, a description of the present invention will be given with reference to the attached drawings. However, it is noted that the description given below is only illustrative and explanatory and is not intended to impose any undue limitation to the protection scope that the present invention is seeking for.

### Embodiment

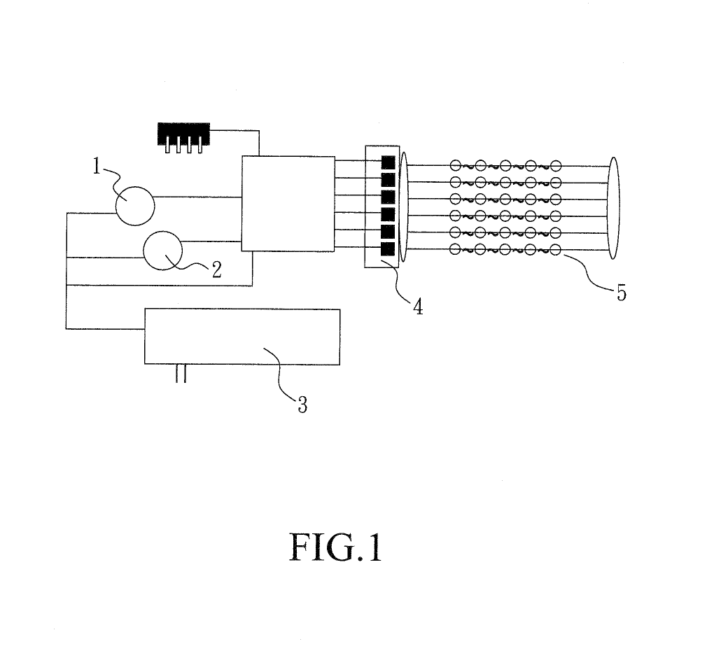

Referring to FIG. 1, based on the characteristics that each individual lighting bulb included in an LED lighting tube consumes only DC 3 V/20 mA:

(1) the lighting bulbs of the LED lighting tube are divided into multiple groups, in which each group consists of a number of lighting bulbs connected in series, groups being connected in parallel to each other, and various divisions for grouping can be selected for lighting tubes of different lengths or based on different requirements, the parallel connected groups having power switches that can be controlled by a control circuit to be individually turned on or off;

(2) based on the principle that an infrared sensor of the human body detection device 1 and a voice sensor of sound control device 2, when detecting a human body or a sound, activate a relay to activate/deactivate the lighting group control circuit 4, the infrared sensor 1 and the voice sensor 2 are designed to be included in the power source driving circuit 3 of the LED lighting tube so that the automatic detection feature can be employed to effectively control the activation and deactivation of the lighting tube.

(3) based on the above descried grouping arrangement and the automatic detection and switching principle, the signal of automatic detection is processed through the circuit and software for controlling purposes to allow a user to determine in what conditions that one group or more groups of the grouping arrangement discussed herein is to be turned on, or to turn off or completely turn on all the lighting bulbs of the lighting tube to realize the purpose of multiple stages of lighting control, whereby better service can be realized for the user and unnecessary lighting can be eliminated to save energy and no additional complicated or unique switch is needed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An energy-saving LED lighting device, comprising a power source driving device, a lighting assembly connected to the power source driving device, a human body detection device, and a sound control device, characterized in that the human body detection device and the sound control device are arranged in the power source driving device.

2. The energy-saving LED lighting device according to claim 1, wherein the lighting assembly comprises at least two groups of lighting elements that are connected in parallel.

3. The energy-saving LED lighting device according to claim 2, wherein the lighting elements comprise at least one lighting unit.

4. The energy-saving LED lighting device according to claim 3, wherein the lighting elements comprise at least two lighting units connected in series.

5. The energy-saving LED lighting device according to claim 3, wherein the lighting units comprise light-emitting diodes.

6. The energy-saving LED lighting device according to claim 4, wherein the lighting units comprise light-emitting diodes.

7. The energy-saving LED lighting device according to claim 1, wherein the human body detection device comprises an infrared sensor and the sound control device comprises a voice sensor.
